(19) United States
(12) Patent Application Publication
(10) Pub. No.: US 2026/0060408 A1
(43) Pub. Date: Mar. 5, 2026

(54) CADDY FOR SUPPORTING LEAF BLOWER AND GUTTER CLEANING KIT

(71) Applicant: Mark Piechowski, West Allis, WI (US)

(72) Inventor: Mark Piechowski, West Allis, WI (US)

(73) Assignee: Mark Piechowski, West Allis, WI (US)

(21) Appl. No.: 18/820,686

(22) Filed: Aug. 30, 2024

(51) Int. Cl. A45F 5/00; B08B 9/00; E04D 13/076

(52) U.S. Cl. CPC A45F 5/00; B08B 9/00; E04D 13/0765; A45F 2005/006

(57) ABSTRACT

A support caddy for an air blower and gutter cleaning kit. The support caddy provides stability for the air blower and the vertical tube assembly of the gutter cleaning kit, allowing users to support the vertical and horizontal forces encountered during gutter cleaning. The caddy includes a base with a lower support wall, a back wall extending perpendicular to the base, and a connecting tube (if required) between the air blower and the gutter cleaning kit. The support caddy includes quick release cinch retaining straps, a front handle, and a support strap for support. The gutter cleaning kit includes a transition piece that directs airflow from horizontal to vertical, and a series of interconnected air tubes that extend the reach of the cleaning kit. The support caddy and gutter cleaning kit are designed to efficiently remove leaves and debris from roof gutters, providing for safer and more effective cleaning.

### BACKGROUND

The disclosed system generally relates to a caddy for supporting an air blower and a gutter cleaning kit during use. More specifically, the present disclosure relates to a support caddy that provides stability for an air blower and the vertical tube assembly of the gutter cleaning kit to allow a user to support the vertical and horizonal forces encountered during cleaning of an elevated gutter.

Roof gutters have been used to control rainwater for decades. Roof gutters collect the water that falls on a roof and divert the water along the roof edge to a downspout, which directs the collected rainwater away from the foundation of the building. Roof gutters are both simple and effective and can be installed on a building for a relatively low cost. However, the simple design of roof gutters makes them effective at catching more than just rainwater. Gutters catch virtually anything that is up on the roof, including debris from trees, including leaves, needles, and seeds. This debris can be very damaging and can clog up the gutter, preventing the proper operation of the gutter.

Leaves will clog a gutter when the accumulation is great enough. The mass of leaves compacts and rots in the standing rainwater and, if the gutter is not securely mounted to the roof, the weight of the accumulated leaves may pull the gutter down or cause other damage. Even if the mass of leaves is insufficient to damage the gutter, the blockage may force the rainwater over the edge of the gutter instead of directing the water toward the downspout. This uncontrolled water defeats the purpose of the gutters and allows the water to pool near the foundation of the building. Many methods have been developed to counter the accumulation of debris in gutters.

The primary method of debris removal is to simply stand on a ladder and scoop the debris out or drop it to the ground. This procedure is messy and can be dangerous, especially to elderly homeowners or those who have mobility issues. In other cases, the edge of the roof that includes the gutter is too high for a household ladder. In such situations, the homeowner may use a ladder to gain access to the roof and remove the debris while standing on the roof. This may be even more dangerous than the first method.

Various styles of gutters or gutter covers have been developed to prevent debris from accumulating in the gutters. These different gutter cover designs can be expensive to purchase and install and may not always work properly. If installed gutters covers do not work properly, they just act to conceal the debris. Thus, the homeowner does not know there is a problem until there is a catastrophic failure of the gutter system. Additionally, these gutter covers, even when working properly, still will have debris built up on top of the gutter cover, thereby requiring debris removal by the homeowner.

Presently, gutter cleaning kits are designed to help users efficiently clean hard-to-reach gutters and other yard areas. A typical gutter cleaning kit includes a 90° transition piece (with the ability to rotate), four extension air tubes, and a nozzle. The gutter nozzle is angled to fit into gutters, allowing for easy vacuuming or blowing out of debris. The tapered blower nozzle makes it quick and easy to blow debris out of the gutters. The extension tubes extend the length of the user's reach, making it easier to tackle hard-to-reach spots. These types of gutter cleaning kits are somewhat standard dimensionally. However, some blowers have rectangular tube configurations that extend to the blower. These blowers require a square-to-round tube converter (supplied with that particular kit) which is incorporated as the connecting tube in the caddy before the 90° transition piece.

The present inventor has recognized the problems associated with currently available gutter cleaning methods and systems and has developed the present disclosure to address these issues. Specifically, today's current leaf blower/gutter cleaning kits fall apart during use due to unsupported tubes and tube extensions, thus requiring the user to use duct tape or a similar mechanism to hold the components together, which is both messy and ineffective.

### SUMMARY

The present disclosure relates to a support caddy for use with an air blower and gutter cleaning kit that includes a series of interconnected air tubes and a transition piece that includes an inlet tube and an outlet tube that is positioned perpendicular to the inlet tube. The support caddy of the present disclosure includes a base with a lower support wall for receiving and supporting the air blower, and a back wall extending perpendicular to the lower support wall. The back wall supports the interconnected air tubes of the gutter cleaning kit using a tube support cylinder. The support caddy includes a connecting tube (where needed) that is held securely in the base portion. The connecting tube is positioned between an outlet of the air blower and the inlet tube of the transition piece. The support caddy further includes a support strap configured to be worn by the user to support the weight of the air blower and the gutter cleaning kit during use.

The outlet tube of the transition piece includes a rotational interface that allows the outlet tube to rotate. A tube support cylinder is positioned to allow one of the air tubes to extend through the tube support cylinder and rotate relative to the tube support cylinder. In this manner, the tube support cylinder allows for rotation of the air tube yet supports the vertical orientation of the series of air tubes. The tube support cylinder is securely attached to the back wall of the support caddy by a series of clamps.

In one contemplated embodiment of the present disclosure, the lower support wall of the base portion of the support caddy can include an air inlet opening that allows air to flow through the lower support wall to the air blower during use.

Additionally, in another contemplated embodiment, the support caddy includes a pair of side walls extending perpendicular to the lower support wall, a plurality of quick release cinch retaining straps to secure the air blower and connecting tube, and a front handle for ease of use. The series of quick release cinch retaining straps hold the air blower in place during use and allows the air blower to be easily removed for other uses.

The present disclosure also relates to a gutter cleaning system that includes an air blower and a gutter cleaning kit that includes a series of interconnected air tubes and a transition piece having an inlet tube and an outlet tube that is positioned perpendicular to the inlet tube. The air blower and the gutter cleaning kit are supported by a support caddy.

The support caddy of the gutter cleaning system includes a base with a lower support wall for receiving and supporting the air blower, and a back wall extending perpendicular to the lower support wall. The back wall supports the interconnected air tubes of the gutter cleaning kit via the tube support cylinder, which is secured to the back wall. The support caddy includes a connecting tube (where needed) that is held securely in the base portion. The connecting tube is positioned between an outlet of the air blower and the inlet tube of the transition piece. The support caddy further includes a support strap configured to be worn by the user to support the weight of the air blower and the gutter cleaning kit during use.

The outlet tube of the transition piece includes a rotational interface that allows the outlet tube to rotate. A tube support cylinder is positioned to allow one of the air tubes to extend through the tube support cylinder and rotate relative to the tube support cylinder. In this manner, the tube support cylinder allows for rotation of the air tube yet supports the vertical orientation of the series of air tubes. The tube support cylinder is securely attached to the back wall of the support caddy by a series of clamps.

In one contemplated embodiment of the present disclosure, the lower support wall of the base portion of the support caddy can include an air inlet opening that allows air to flow through the lower support wall to the air blower during use.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a user using the system of the present disclosure to remove debris from a gutter attached to a building;

FIG. 2 is a partially exploded perspective view showing an air blower removed from the support caddy;

FIG. 3 is a further exploded view showing the components of the support caddy removed from the base portion;

FIG. 4 is a section view of the base of FIG. 1 with the air blower shown in dashed lines;

FIG. 5A is a section view taken along line 5A-5A of FIG. 4;

FIG. 5B is a view similar to FIG. 5A showing the rotation of the outlet nozzle of the gutter cleaning kit; and

FIG. 6 is a view showing the components of a gutter cleaning kit.

### DETAILED DESCRIPTION

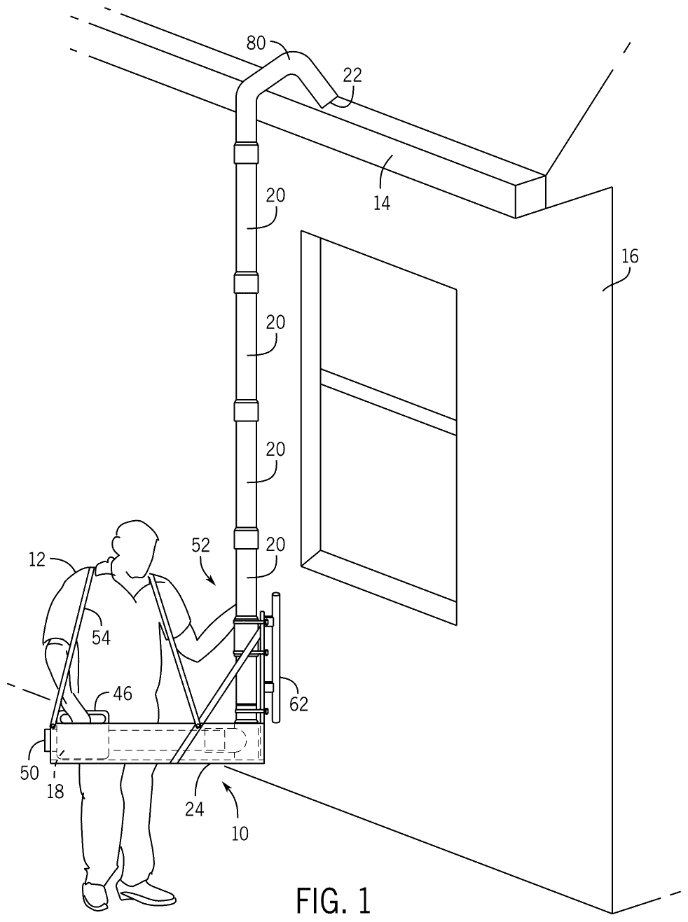

FIG. 1 illustrates a support caddy 10 being used by a user 12 to clean and remove leaves and debris from a gutter 14 of a home 16. As illustrated, the user 12 is able to hold and support the support caddy 10 and move the support caddy 10 along the length of the gutter 14 to remove leaves and other debris from the gutter 14. The support caddy 10 is used to support an air blower 18 that is operable to create a flow of air that is forced through a gutter cleaning kit 52 that includes a series of interconnected air tubes 20 and out through a nozzle 22 to direct the air flow into the open interior of the gutter 14.

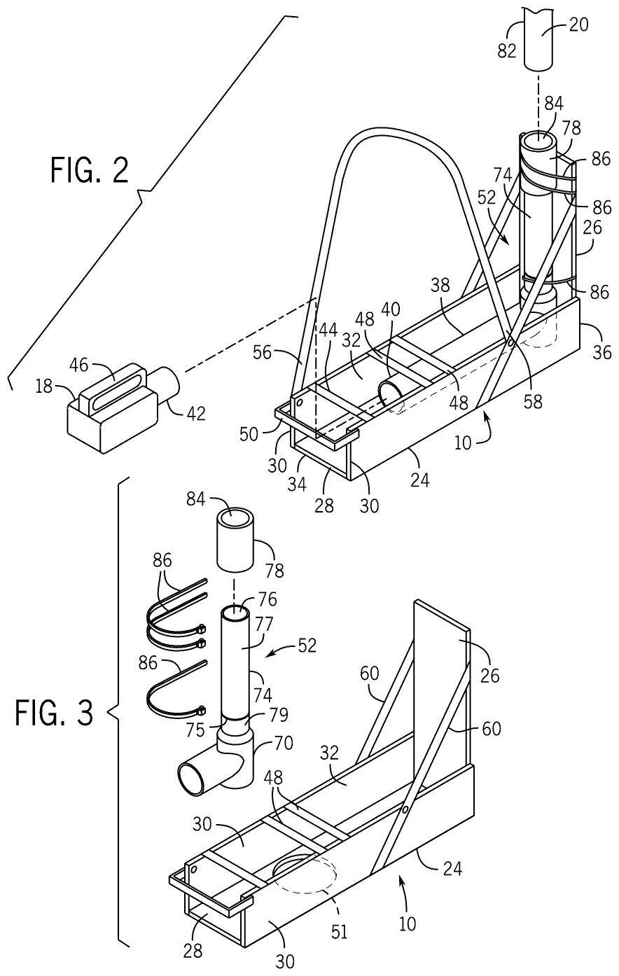

In the embodiment illustrated, the air blower 18 includes an electric motor that generates the air flow directed away from the air blower 18. The air blower 18 could be either connected to a power cord to provide electric power to the internal motor, could be battery operated or could be gas powered depending upon the specific configuration of the air blower 18. In the embodiment illustrated, the air blower 18 is connected to a supply of electricity through an extension cord (not shown) in a manner as will be described in greater detail below. Additionally, it is contemplated that the various different types of air blowers 18 could have different outlet configurations. Some, such as shown in FIG. 2, have a round male connection while others may have a round female connection or a rectangular male or rectangular female connection.

FIGS. 2 and 3 illustrate the detailed configuration for one embodiment of the support caddy 10 constructed in accordance with the present disclosure. In the embodiment shown in FIGS. 2 and 3, the support caddy 10 includes a base portion 24 that is connected to a back wall 26. The base portion 24 includes a lower support wall 28 and a pair of side walls 30 that are connected to and joined to the lower support wall 28. In the embodiment illustrated, the side walls 30 are each perpendicular to the lower support wall 28 and define a generally open interior 32 that extends from a front end 34 to a back end 36. The open interior 32 is designed to receive the air blower 18 along with a connecting tube 38. The connecting tube 38 (where needed) has an inlet end 40 that is sized to receive an outlet nozzle 42 formed as part of the air blower 18. The outlet nozzle 42 of the air blower 18 has an outer diameter slightly smaller than the inner diameter of the inlet tube 40 such that the outlet nozzle 42 can be received within the inlet end 40. The connection configuration shown could vary depending on the blower manufacturer and the corresponding gutter cleaning kit. The support caddy 10 of the present disclosure is designed to accommodate all of the variations while operating in accordance with the present disclosure.

As shown in FIGS. 1 and 2, when the air blower 18 is installed within the base portion 24, the air blower 18 is held securely in place by a first quick release cinch retaining strap 44 that extends across the top of the open interior 32 between the pair of spaced side walls 30. The quick release cinch retaining strap 44 is used to securely hold the air blower 18 in place and preferably extends in a manner such that the handle portion 46 of the air blower 18 is accessible and usable by the user 12 to help support the weight of the entire support caddy 10. In a contemplated embodiment, the quick release cinch retaining strap 44 can extend through the handle portion 46 to further aid in supporting the weight of the base portion 24, including the air blower 18. The quick release cinch retaining strap 44 is configured such that it can be quickly and easily removed to allow the air blower 18 to be quickly and easily removed from the support caddy 10 to be used in other applications.

Referring back to FIGS. 2 and 3, the base portion 24 further includes one or more quick release cinch retaining straps 48 that again extend between the pair of spaced side walls 30. The pair of quick release cinch retaining straps 48 aid in holding the connecting tube 38 (where needed) within the open interior 32 during use of the support caddy 10 and air blower 18.

The support caddy 10 further includes a front handle 50 that extends between the pair of spaced side walls 30 and protrudes past the front end 34 of the base portion 24. The front handle 50 can be formed from a metal or plastic material and provides a convenient place for the user 12 to grasp when lifting and moving the combination of the air blower and gutter cleaning kit. As shown in FIG. 3, the lower support wall 28 includes an air inlet opening 51 that is a removed area of the support wall 28. The air inlet opening 51 is positioned below the air blower 18 to allow the air blower to draw in air during operation when it is supported in the base portion 24. The air inlet opening 51 could include a mesh covering in a contemplated embodiment or could be open as is illustrated.

Referring back to FIG. 1, when the user 12 is utilizing the support caddy 10 to operate the combination of the air blower 18 and gutter cleaning kit 52, the weight of the support caddy 10, air blower 18 and gutter cleaning kit 52 can be supported along the shoulders of the user by a support strap 54 that can extend around the neck of the user 12 as illustrated. As shown in FIG. 2, the support strap 54 has a first end 56 securely connected to the first side wall 30 while a second end 58 is secured to the opposite side wall 30. The first and second ends 56, 58 can be secured to the side walls 30 utilizing any type of secure attachment method, such as a rivet. The support strap 54 can be formed from a variety of materials, such as woven nylon, leather, woven cotton or any other type of durable material that is sufficient to support the weight of the support caddy, air blower and gutter cleaning kit during operation. In the embodiment shown, each of the first and second ends 56, 58 of the support strap 54 are secured to an outer surface of the side wall 30 such that the point of connection between the support strap 54 and the side walls 30 is outside of the open interior 32.

Referring now to FIGS. 2 and 3, the support caddy 10 further includes a pair of angular support members 60 that are each positioned and mounted to support the back wall 26 in its perpendicular orientation relative to the lower support wall 28 of the base portion 24. Each of the angular support members 60 extend between one of the side walls 30 and the back wall 26 to prevent the back wall 26 from moving outward and away from the open interior 32 defined within the base portion 24. The angular support members 60 can be formed from a wide variety of different types of durable material, such as nylon, plastic, metal or other types of materials that are durable and strong enough to support the back wall 26 in the perpendicular position relative to the lower support wall 28 of the base portion 24. It is contemplated that the angular support members 60 could be formed from a continuous strap of material that passes beneath the base portion 24 and around the back surface of the back wall 26. Alternatively, each of the angular support members 60 could be a separate structure that is securely attached to the back wall 26 and to the side walls 30.

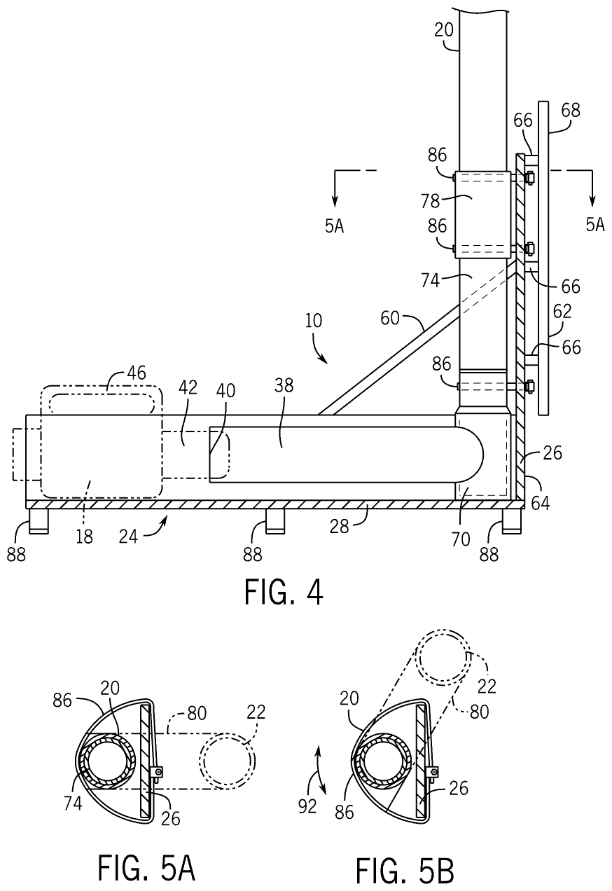

Referring now to FIGS. 1 and 4, in one exemplary embodiment of the present disclosure, the support caddy 10 can include a cord wrapping post 62 that is mounted to the back surface 64 of the back wall 26. The cord wrapping post 62 is set off from the back surface 64 by a series of standoffs 66 that create spacing between the back surface 64 and an inner surface 68 of the cord wrapping post 62. The spacing allows an electric extension cord (not shown) to be wrapped around the cord wrapping post 62. The electric extension cord that can be connected to the air blower 18 to increase the range of use of the air blower and gutter cleaning kit. In embodiments in which the support caddy 10 is used with a battery powered or gas-powered air blower, the cord wrapping post 62 could be removed or simply not utilized.

Referring back to FIGS. 2 and 3, the support caddy 10 is designed to support not only the air blower 18 but also the gutter cleaning kit 52. The gutter cleaning kit 52 is designed to interface with the connecting tube 38 that is supported and retained within the base portion 24 of the support caddy 10. Depending on the size and configuration of the air blower 18, the connecting tube 38 may not be required to create the connection between the air blower and the gutter cleaning kit 52. As shown in FIG. 3, the gutter cleaning kit 52 includes a transition piece 70 that includes an inlet tube 72 and an outlet tube 74 that is positioned perpendicular to the inlet tube 72. In some embodiments, the air inlet tube 72 will be connected to the connecting tube 38 while in other embodiments, the air inlet tube 72 could connect directly to the outlet nozzle 42 of the air blower 18. The transition piece 70 allows the flow of air to transition from a horizontal direction to a vertical direction within the transition piece 70. The outlet tube 74 includes a rotational interface 75 that allows the upper portion 77 to rotate relative to a stationary lower portion 79 and the transition piece 70. This rotational motion is supported by the tube support cylinder 78, which allows rotation yet provides structural strength for the extended series of air tubes. The upper portion 77 includes an outlet end 76 that is connected to the first air tube passing through the tube support cylinder 78. The tube support cylinder 78 is designed to support the outlet tube 74 while allowing the upper portion 77 to freely rotate. The upper portion 77 of the vertical outlet tube 74 is connected to a first one of a series of connected air tubes 20, as shown in FIG. 2. As shown in FIG. 1, the gutter cleaning kit 52 of the exemplary embodiment includes four air tubes 20 that are joined to each other to increase the overall reach of the gutter cleaning kit 52. It is contemplated that the gutter cleaning kit 52 could include fewer or additional air tubes 20 depending on the height of the home including the gutters being cleaned. The uppermost air tube 20 is joined to the nozzle tube 80 which includes a pair of bends that direct the air flow to the air nozzle 22 at its outer end.

Referring back to FIGS. 2 and 3, the diameter of the tube support cylinder 78 has an inner diameter sized to support the air tube extension 20 yet provides structural strength fo the extended series of air tubes. The rotational interface 75, supported up stream by the tube support cylinder 78 will allow the connected air tubes 20 to rotate within the tube support cylinder 78 and be supported structurally throughout the working length of the joined air tubes 20.

As shown in FIGS. 2 and 3, a series of clamps 86 are used to secure both the tube support cylinder 78 and the transition piece 70 and the stationary position 79 to the back wall 26. Each of the clamps 86 extends around the entire back wall 26 and holds the tube support cylinder 78 in the position shown in FIG. 2. The clamps 86 support the tube support 78, which in turn supports the air tube 20 and the additional air tubes connected to the lower air tube 20. The clamps 86 can be formed from a variety of different materials, such as metal or plastic. It is contemplated that each of the clamps 84 can be removed and released should the user wish to remove the transition piece 70 and the outlet tube 74.

Referring now to FIG. 4, the base portion 24 further includes a series of standoffs 88 that provide support for the lower support wall 28 when the entire support caddy 10 is set down onto a ground surface. As can be seen in the section view shown in FIG. 4, the outlet nozzle 42 of the air blower 18 is received within the inlet end 40 of the connecting tube 38 (if needed) such that the air flow created by the air blower 18 enters into the connecting tube 38 is directed toward the transition piece 70.

FIGS. 5A and 5B are a section view taken along line 5A-5A in FIG. 4 and show the ability of the nozzle tube 80 and outlet nozzle 22 to rotate upon the user grabbing the air tube 20 by hand and rotating the air tube 20 as desired. The air tube 20 rotates along with the upper portion of the outlet tube 74, which includes the rotational interface 75. The movement of the outlet nozzle 22 allows the user to control the direction of the outlet air flow to clean the gutter 14 as shown in FIG. 1.

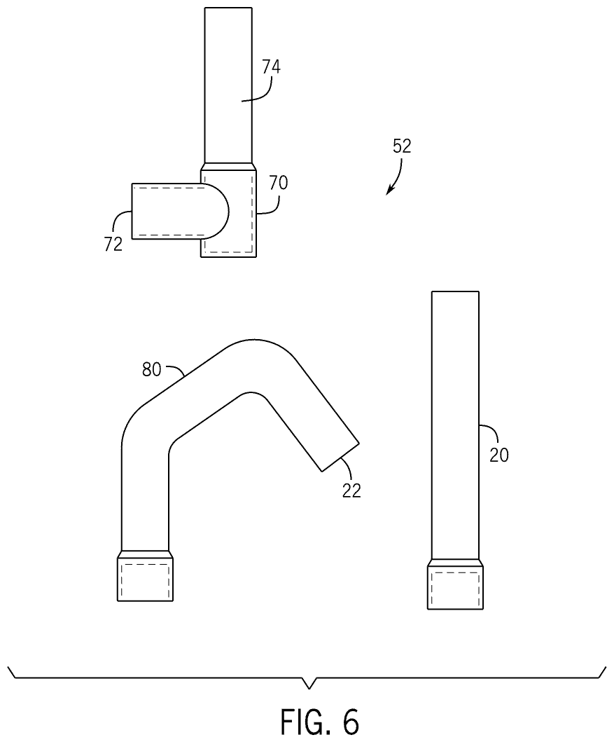

Referring now to FIG. 6, the individual components previously described that form the gutter cleaning kit 52 are shown in their disassembled condition. As previously described, the gutter cleaning kit includes the transition piece 70, which includes the outlet tube 74 and inlet tube 72. The gutter cleaning kit 52 can include a series of air tubes 20 that can be joined to each other to define the overall height and reach of the gutter cleaning kit as shown in FIG. 1. Finally, the gutter cleaning kit includes the nozzle tube 80 that terminates at the outlet nozzle 22. The gutter cleaning kit 52 is part of a conventional gutter cleaning kit that can be utilized with the support caddy of the present disclosure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A support caddy for use by a user with an air blower and gutter cleaning kit that includes a series of interconnected air tubes and a transition piece including an inlet tube and an outlet tube positioned perpendicular to the inlet tube, the support caddy comprising:
a base portion having a lower support wall for receiving and supporting the air blower;
a back wall extending perpendicular to the lower support wall, wherein the back wall supports the interconnected air tubes; and
a support strap connected to the base and configured to be received on the user to support the weight of the air blower and the gutter cleaning kit.

2. The support caddy of claim 1 further comprising an air inlet opening formed in the lower support wall of the base to allow air flow to the air blower during operation of the air blower.

3. The support caddy of claim 1 wherein the base includes a pair of side walls extending perpendicular to the lower support wall.

4. The support caddy of claim 3 further comprising a plurality of quick release cinch retaining straps extending between the pair of side walls, wherein the plurality of retaining straps retain the air blower and the connecting tube within the base.

5. The support caddy of claim 3 further comprising a pair of angular support members extending between the pair of side walls and the back wall to support the back wall relative to the lower support wall.

6. The support caddy of claim 1 further comprising a connecting tube supported by the lower support wall and positioned to extend between the air blower and the inlet tube of the transition piece.

7. The support caddy of claim 1 wherein the outlet tube includes a lower portion and an upper portion joined to each other by a rotational interface, wherein the upper portion is configured to receive one of the air tubes.

8. The support caddy of claim 1 further comprising a tube support cylinder position securely attached to the back wall, wherein the tube support cylinder allows the upper portion of the outlet tube to rotate within the tube support cylinder.

9. The support caddy of claim 8 further comprising a plurality of clamps to attach the tube support cylinder to the back wall.

10. The support caddy of claim 1 further comprising a cord wrapping post mounted to an outer surface of the back wall.

11. A gutter cleaning system for use by a user, comprising:
an air blower operable to create an airflow out of an outlet nozzle;
a gutter cleaning kit that includes a series of interconnected air tubes and a transition piece including an inlet tube and an outlet tube positioned perpendicular to the inlet tube; and
a support caddy comprising:
a base portion having a lower support wall for receiving and supporting the air blower;
a back wall extending perpendicular to the lower support wall, wherein the back wall is coupled to and supports the transition piece and the interconnected air tubes; and
a support strap connected to the base and configured to be received on the user to support the weight of the air blower and the gutter cleaning kit.

12. The gutter cleaning system of claim 11 further comprising an air inlet opening formed in the lower support wall of the base to allow air flow to the air blower during operation of the air blower.

13. The gutter cleaning system of claim 11 wherein the base includes a pair of side walls extending perpendicular to the lower support wall.

14. The gutter cleaning system of claim 13 further comprising a plurality of quick release cinch retaining straps extending between the pair of side walls, wherein the plurality of quick release cinch retaining straps retain the air blower within the base.

15. The gutter cleaning system of claim 13 further comprising a pair of angular support members extending between the pair of side walls and the back wall to support the back wall relative to the base.

16. The gutter cleaning system of claim 13 further comprising a connecting tube supported by the lower support wall and positioned to extend between the air blower and the inlet tube of the transition piece.

17. The gutter cleaning system of claim 10 further comprising a tube support cylinder positioned to allow rotation of the outlet tube of the transition piece and the series of interconnected air tubes, wherein the tube support cylinder is securely attached to the back wall.

18. The gutter cleaning system of claim 17 further comprising a plurality of clamps to attach the tube support cylinder to the back wall.

19. The gutter cleaning system of claim 11 further comprising a cord wrapping post mounted to an outer surface of the back wall.

20. A support caddy for use by a user with an air blower and gutter cleaning kit that includes a series of interconnected air tubes, the support caddy comprising:
a base portion having a lower support wall for receiving and supporting the air blower;
a back wall extending perpendicular to the lower support wall, wherein the back wall supports the interconnected air tubes;
a transition piece including a body portion, an inlet tube and an outlet tube positioned perpendicular to the inlet tube, wherein an upper portion of the outlet tube is rotatable relative to the body portion and the inlet tube;
a tube support cylinder positioned to provide support and allow rotation of the outlet tube of the transition piece and the series of interconnected air tubes, wherein the tube support cylinder is securely attached to the back wall; and
a support strap connected to the base and configured to be received on the user to support the weight of the air blower and the gutter cleaning kit.
